(19) United States
(12) Patent Application Publication
(10) Pub. No.: US 2026/0095941 A1
(43) Pub. Date: Apr. 2, 2026

(54) Network Allocation Vector Setting and Updating During a Transmission Opportunity

(71) Applicant: Apple Inc., Cupertino, CA (US)

(72) Inventors: Yong Ho SEOK, Cupertino, CA (US); Abdel Karim AJAMI, San Jose, CA (US); Anuj BATRA, Redwood City, CA (US); Morteza MEHRNOUSH, Hayward, CA (US); Neelakantan NURANI KRISHNAN, San Diego, CA (US); Qi WANG, Mountain View, CA (US); Su Khiong YONG, Palo Alto, CA (US); Yong LIU, Campbell, CA (US)

(21) Appl. No.: 19/332,371

(22) Filed: Sep. 18, 2025

Related U.S. Application Data
(60) Provisional application No. 63/700,164, filed on Sep. 27, 2024.

(51) Int. Cl. H04W 74/0816; H04W 74/0838; H04W 84/12

(52) U.S. Cl. CPC H04W 74/0816; H04W 74/0838; H04W 84/12

(57) ABSTRACT

An apparatus configured to generate, for transmission, an initial control frame (ICF) for a transmission opportunity (TXOP) comprising a first duration and a second duration, wherein the first duration is set based on a time for a TXOP responder station to respond to the ICF with an initial control response (ICR) and a Short Interframe Space (SIFS), and wherein the second duration is set based on a time for data to be transmitted to the TXOP responder station, process, based on signaling received from the TXOP responder station, the ICR and generate, for transmission to the TXOP responder station, one or more data transmissions during the TXOP.

### PRIORITY/INCORPORATION BY REFERENCE

This application claims priority to U.S. Provisional Application Ser. No. 63/700,164 filed on Sep. 27, 2024, and entitled “Network Allocation Vector Setting and Updating During a Transmission Opportunity,” the entirety of which is incorporated by reference herein.

### BACKGROUND

IEEE 802.11 networks may operate using stations having the latest IEEE 802.11 communication protocols and stations that are operating using legacy IEEE 802.11 communication protocols. Since the latest IEEE 802.11 communication protocols generally improve station performance, there may be scenarios where station operating with legacy IEEE 802.11 communication protocols are treated unfairly in the network. Since the goal of the IEEE 802.11 communication protocols is to be backwards compatible, this unfairness to legacy stations should be avoided.

### SUMMARY

Some example embodiments are related to an apparatus having processing circuitry coupled to memory, wherein the processing circuitry is configured to generate, for transmission, an initial control frame (ICF) for a transmission opportunity (TXOP) comprising a first duration and a second duration, wherein the first duration is set based on a time for a TXOP responder station to respond to the ICF with an initial control response (ICR) and a Short Interframe Space (SIFS), and wherein the second duration is set based on a time for data to be transmitted to the TXOP responder station, process, based on signaling received from the TXOP responder station, the ICR and generate, for transmission to the TXOP responder station, one or more data transmissions during the TXOP.

Other example embodiments are related to an apparatus having processing circuitry coupled to memory, wherein the processing circuitry is configured to process, based on signaling received from a transmission opportunity (TXOP) holder station, an initial control frame (ICF) for a TXOP comprising a first duration and a second duration, wherein the first duration is set based on a time to respond to the ICF with an initial control response (ICR) and a Short Interframe Space (SIFS), and wherein the second duration is set based on a time for data to be transmitted by the TXOP holder station, generate, for transmission to the TXOP holder station, the ICR, wherein the ICR comprises the second duration and process, based on signaling received from the TXOP holder station, one or more data transmissions during the TXOP.

Still further example embodiments are related to an apparatus having processing circuitry coupled to memory, wherein the processing circuitry is configured to process, based on signaling received from a transmission opportunity (TXOP) holder station, an initial control frame (ICF) for a TXOP destined for a TXOP responder station, the ICF comprising a first duration and a second duration, wherein the apparatus is not the TXOP responder station, wherein the first duration is set based on a time to respond to the ICF with an initial control response (ICR) and a Short Interframe Space (SIFS), and wherein the second duration is set based on a time for data to be transmitted by the TXOP holder station to the TXOP responder station and set a network allocation vector (NAV) duration based on the first duration and the second duration, wherein the apparatus does not contend for a channel during the NAV duration.

Additional example embodiments are related to an apparatus having processing circuitry coupled to memory, wherein the processing circuitry is configured to process, based on signaling received from a transmission opportunity (TXOP) responder station, an initial response frame (ICR) for a TXOP destined for a TXOP holder station, the ICR comprising a first duration, wherein the apparatus is not the TXOP holder station, wherein the first duration is set based on a time for data to be transmitted by the TXOP holder station to the TXOP responder station and set a network allocation vector (NAV) duration based on the first duration, wherein the apparatus does not contend for a channel during the NAV duration.

More example embodiments are related to an apparatus having processing circuitry coupled to memory, wherein the processing circuitry is configured to process, based on signaling received from a transmission opportunity (TXOP) holder station, an initial control frame (ICF) for a TXOP destined for a TXOP responder station, the ICF comprising a first duration, wherein the apparatus is not the TXOP responder station, wherein the first duration is set based on a time to respond to the ICF with an initial control response (ICR) and a Short Interframe Space (SIFS) and set a network allocation vector (NAV) duration based on the first duration, wherein the apparatus does not contend for a channel during the NAV duration.

### BRIEF DESCRIPTION OF THE DRAWINGS

FIG. 1 shows an example arrangement of components in an 802.11 network according to various example embodiments.

FIG. 2 shows an example timing diagram for an uplink transmission in the example arrangement of FIG. 1.

FIG. 3 shows an example arrangement of components in an 802.11 network according to various example embodiments.

FIG. 4 shows an example timing diagram for a downlink transmission in the example arrangement of FIG. 3.

FIG. 5 shows an example timing diagram where a first station is a TXOP holder and a second station is a TXOP responder according to various example embodiments.

FIG. 6 shows an example arrangement comprising multiple stations according to various example embodiments.

FIG. 7 shows an example timing diagram of TXOP holder and TXOP responder communications when other stations are 802.11bn stations according to various example embodiments.

FIG. 8 shows an example timing diagram of TXOP holder and TXOP responder communications when other stations are legacy stations according to various example embodiments.

FIG. 9 shows an example timing diagram of TXOP holder and TXOP responder communications when other stations are 802.11bn stations and a network allocation vector (NAV) is updated according to various example embodiments.

FIG. 10 shows an example wireless communication device according to various example embodiments.

### DETAILED DESCRIPTION

The example embodiments may be further understood with reference to the following description and the related appended drawings, wherein like elements are provided with the same reference numerals. The example embodiments relate to network allocation vector (NAV) of a third party station being set or reset based on information included in an initial control frame (ICF) of a transmission opportunity (TXOP), an initial control response (ICR) of the TXOP or a data transmission of the TXOP. The example embodiments provide operations for setting the NAV by legacy stations and current stations.

The example embodiments are described with reference to the IEEE 802.11 that provide communication protocols for devices to communicate via wireless connections. There are multiple releases of the 802.11 protocols (e.g., 802.11ax, 802.11be, 802.11bn, etc.) Reference to 802.11 in the example embodiments may refer to any release of the 802.11 protocols unless a specific release is identified in the description.

The example embodiments are described with regard to a wireless communication device. Typically, a wireless communication device in 802.11 networks may be referred to as a station (or STA). In the example embodiments, a station may refer to an end point device such as a mobile phone, tablet computer, desktop computer, smartphone, embedded device, wearable, Internet of Things (IoT) device, video game console, media player, entertainment device, smart speakers, smart TV, streaming devices, etc. The station may also refer to intermediate points in the 802.11 network including access points (APs), routers, switches, etc. Thus, any reference to a station or wireless communication device in the example embodiments may refer to any device capable of wirelessly communicating using the 802.11 protocol.

The example embodiments are described with reference to IEEE 802.11 that provide communication protocols for devices to communicate via wireless connections. There are multiple releases of the 802.11 protocols (e.g., 802.11ax, 802.11be, 802.11bn, etc.) Reference to 802.11 in the example embodiments may refer to any release of the 802.11 protocols unless a specific release is identified in the description. In the description, the current protocol may be considered to be the 802.11bn release. Other releases may be considered to be legacy releases. However, as the 802.11 standard develops, there may be new releases and the example embodiments may also apply to these new releases.

The example embodiments are also described with reference to various durations. Some example embodiments and drawings show specific time values for these durations. These specific time values are only examples used for illustrative purposes. The various durations may have other time values when the example embodiments are implemented.

The example embodiments provide operations for a third party station to set a NAV based on information included in ICFs, ICRs or data transmissions of TXOP holders or TXOP responders. Specifically, the ICFs, ICRs or data transmissions may include one or more durations in a Medium Access Control (MAC) header or a physical (PHY) layer header that the third party station may use to set the NAV. This setting of the NAV may include both initial setting of the NAV for the TXOP, setting of multiple NAVs during the TXOP (e.g., for legacy stations) or resetting the NAV. The setting of the NAV may be applied differently to stations operating using a current release of the 802.11 communication protocols and stations operating using legacy releases of the 802.11 communication protocols. Each of these example aspects will be described in greater detail below.

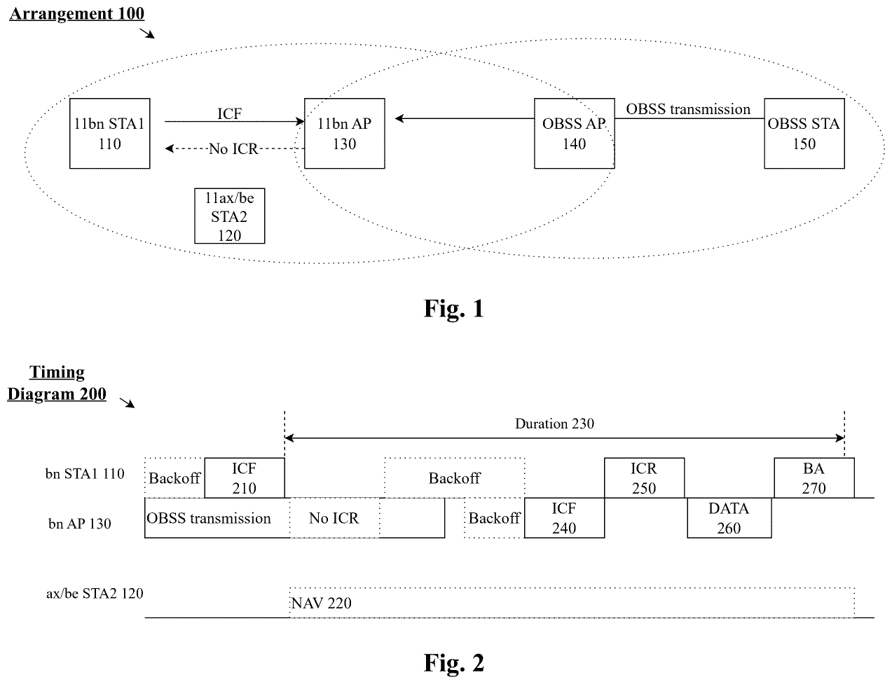

FIG. 1 shows an example arrangement 100 of components in an 802.11 network according to various example embodiments. The arrangement 100 comprises an 802.11bn station 110, an 802.11ax/be station 120, an 802.11bn AP 130, an Overlapping Basic Service Sets (OBSS) AP 140 and an OBSS station 150. This example arrangement illustrates an uplink (UL) scenario where the 802.11bn station 110 is attempting to send data to the 802.11bn AP 130.

The example arrangement 100 shows the stations 110-140 communicating using an 802.11 access network. The stations 110-140 may represent any type of electronic component that is capable of wirelessly communicating using the 802.11 communication protocols. Specific examples include, but are not limited to, mobile phones, tablet computers, desktop computers, smartphones, embedded devices, wearables, Internet of Things (IoT) devices, video game consoles, media players, entertainment devices, smart speakers, smart TVs, streaming devices, etc. The stations 110-140 may including APs, routers, switches, etc. Therefore, the stations 110-140 may have an Industrial, Scientific and Medical (ISM) chipset to communicate using the 802.11 communication protocols. Any association procedure may be performed for the stations 110-140 to interconnect within the 802.11 access network 130.

FIG. 2 shows an example timing diagram 200 for an uplink transmission in the example arrangement of FIG. 1. As stated above, the uplink transmission is between the 802.11bn station 110 and the 802.11bn AP 130. In the arrangement 100 of FIG. 1, the 802.11bn station 110 and the 802.11ax/be station 120 may be hidden from the OBSS transmissions, e.g., the 802.11bn station 110 and the 802.11ax/be station 120 may not know that there are OBSS transmissions occurring. After a backoff period, the 802.11bn station 110 may send an initial control frame (ICF) 210 to the 802.11bn AP 130 to initiate a transmission opportunity (TXOP). However, the 802.11bn AP 130 may not respond with an initial control response (ICR) because of the OBSS transmissions as shown in FIG. 2.

In this scenario, the 802.11ax/be station 120 may set a network allocation vector (NAV) 220 based on the ICF 210. The NAV is a time during which the 802.11ax/be station 120 may not contend for the channel because the 802.11ax/be station 120 assumes the 802.11bn station 110 is transmitting during the duration 230 that is set based on information in the ICF 210. On the other hand, the 802.11bn station 110 and the 802.11bn AP 130 may implement NAV resetting for the ICF 210. This means that the 802.11bn station 110 and the 802.11bn AP 130 may access the medium during the duration 23 after the failure of the 802.11bn AP 130 to respond with an ICR to the ICF 210. In the example of FIG. 2, this medium access is shown as a downlink transmission from the 802.11bn AP 130 to the 802.11bn station 110. For example, the 802.11bn AP 130 sends an ICF 240 to the 802.11bn station 110 to initiate a TXOP. The TXOP responder 802.11bn station 110 responds with an ICR 250. Then, the TXOP holder 802.11bn AP 130 transmits data 260 (e.g., physical layer protocol data unit (PPDU)) to the 802.11bn station 110, which then responds with a block acknowledgment (BA) 270.

Thus, in this scenario, the 802.11bn station 110 and the 802.11bn AP 130 may have more opportunities to access the medium, leading to a decrease in the performance of the other legacy 11ax/be stations that do not have the NAV resetting capability for the ICF, e.g., the 802.11ax/be station 120.

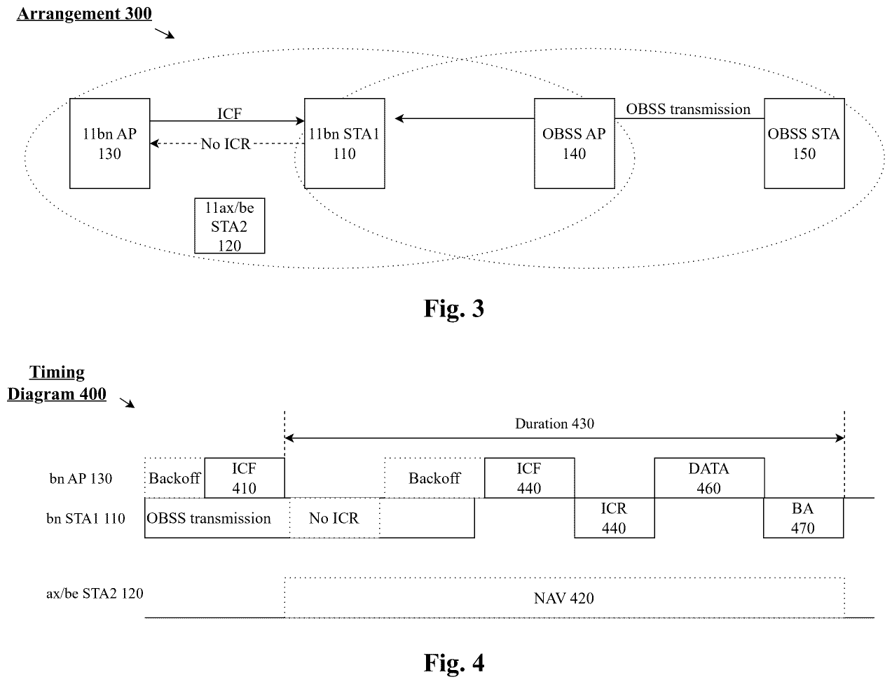

FIG. 3 shows an example arrangement 300 of components in an 802.11 network according to various example embodiments. The arrangement 300 again comprises the 802.11bn station 110, the 802.11ax/be station 120, the 802.11bn AP 130, the OBSS AP 140 and the OBSS station 150. This example arrangement illustrates a downlink (DL) scenario where the 802.11bn AP 130 is attempting to send data to the 802.11bn station 110.

FIG. 4 shows an example timing diagram 400 for a downlink transmission in the example arrangement of FIG. 3. As stated above, the downlink transmission is between the 802.11bn AP 130 and the 802.11bn station 110. In the arrangement 300 of FIG. 1, the 802.11bn AP 130 may be hidden from the OBSS transmissions, e.g., the 802.11bn AP 130 may not know that there are OBSS transmissions occurring. After a backoff period, the 802.11bn AP 130 may send an ICF 410 to the 802.11bn station 110 to initiate a TXOP. However, the 802.11bn station 110 may not respond with an ICR because of the OBSS transmissions as shown in FIG. 4.

In this scenario, the 802.11ax/be station 120 may set a network allocation vector (NAV) 420 based on the ICF 410. Again, the 802.11bn station 110 and the 802.11bn AP 130 may implement NAV resetting for the ICF 210. This means that the 802.11bn station 110 and the 802.11bn AP 130 may access the medium during the duration 430 after the failure of the 802.11bn station 110 to respond with an ICR to the ICF 410. In the example of FIG. 4, this medium access is shown as a downlink transmission from the 802.11bn AP 130 to the 802.11bn station 110. For example, the 802.11bn AP 130 sends an ICF 440 to the 802.11bn station 110. The 802.11bn station 110 responds with an ICR 450. Then, the 802.11bn AP 130 transmits data 460 (e.g., PPDU) to the 802.11bn station 110, which then responds with a BA 470.

Thus, also in this scenario, the 802.11bn station 110 and the 802.11bn AP 130 may have more opportunities to access the medium, leading to a decrease in the performance of the other legacy 11ax/be stations that do not have the NAV resetting capability for the ICF, e.g., the 802.11ax/be station 120.

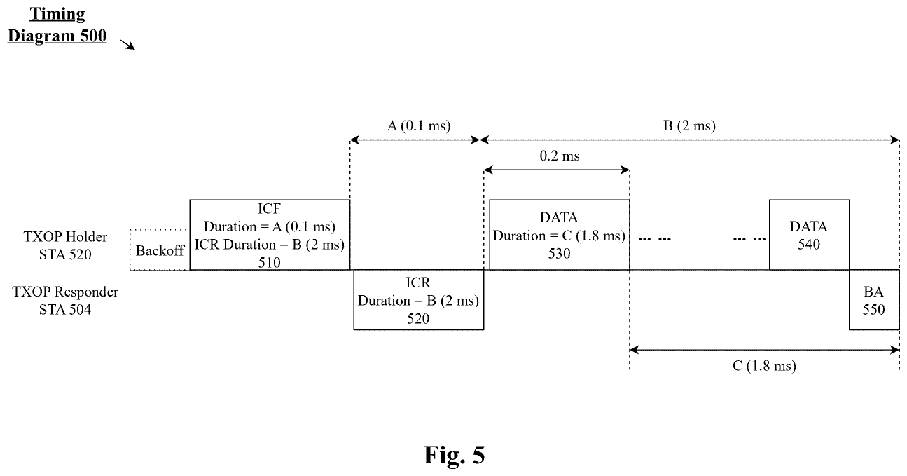

The example embodiments are related to operations that may resolve the issues described above. Specifically, the example embodiments are related to incremental NAV updates based on timing information included in ICFs and ICRs. The example embodiments are described in greater detail below with reference to FIGS. 5-9.

FIG. 5 shows an example timing diagram 500 where a first station 502 is a TXOP holder and a second station 504 is a TXOP responder according to various example embodiments. In the example of FIG. 5, the TXOP holder station 502 may be an AP station or a non-AP station. Similarly, the TXOP responder station 504 may be an AP station or a non-AP station. As will be described in greater detail below, in the example of FIG. 5, the exchange between the TXOP holder 502 and the TXOP responder 504 is successful. Thus, the issue described above with respect to FIGS. 2 and 4 may not occur because the original TXOP responder responds with an ICR. However, as will be described below, the exchange between the TXOP holder 502 and the TXOP responder 504 described with reference to FIG. 5 may resolve the issues of FIGS. 2 and 4 when the TXOP responder does not transmit an ICR in response to an ICF transmitted by the TXOP holder.

After a backoff period, the TXOP holder station 502 may transmit an ICF 510. The ICF 510 may include an indication of two durations, e.g., in a Medium Access Control (MAC) header and/or frame body. A first duration (A) may be set to a time corresponding to the time to transmit an ICR plus a Short Interframe Space (SIFS). The SIFS allows the TXOP holder station 502 to switch from a transmitting mode to a receiving mode. In this example, this time is 0.1 ms as shown in the ICF 510 and in the timeline. In this example, the ICF 510 may also include a second duration (B). This second duration (B) may be set to a time that is used by the TXOP holder to perform the data transmissions with the TXOP responder. In the example of FIG. 5, this duration B may be 2 ms but this is only an example. The use of this second duration B in the MAC header or frame body of the ICF 510 is described in further detail below. In addition, other stations receiving the ICF 510 may set the NAV based on the ICF. The manner in which the other stations may set the NAV is described in greater detail below.

In the example of FIG. 5, the TXOP responder station 504 transmits an ICR 520 in response to the ICF 510. In this case, the TXOP holder station 502 may hold the channel for the full duration of the TXOP to perform the transmissions with the TXOP responder station 504. Thus, the TXOP responder station 504 may transmit the duration B in the MAC header of the ICR 520. As described above, the ICF 510 also includes the duration B and the TXOP responder station 504 receives this duration B when processing the ICF 510, e.g., the TXOP responder station 504 may not know how long the TXOP duration will be but relies on the information transmitted by the TXOP holder station 502 to set this value. Thus, when the TXOP responder station 504 transmits the ICR 520 in response to the ICF 510, the TXOP responder station 504 includes the duration B in the MAC header of the ICR 520 so that other stations may set the NAV.

The timing diagram 500 continues with the TXOP holder station 502 transmitting data to the TXOP responder station 504 during the duration B as shown by the data transmissions 530 and 540 and the BA 550 sent by the TXOP responder station 504 in response to the data transmissions 530 and 540.

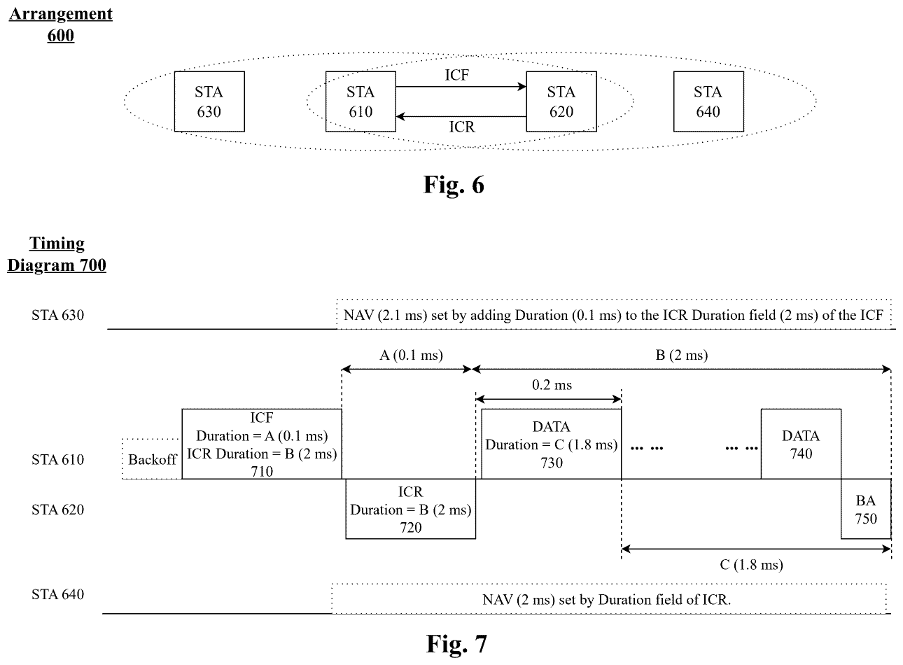

FIG. 6 shows an example arrangement 600 comprising multiple stations according to various example embodiments. The arrangement 600 includes a first station 610 and a second station 620 that are exchanging the ICF and ICR, e.g., the first station 610 is a TXOP holder and the second station 620 is a TXOP responder. For example, the first station 610 that is the TXOP holder may operate in a similar manner as the TXOP holder station 502 described above. Similarly, the second station 620 that is the TXOP responder may operate in a similar manner as the TXOP responder station 504 described above.

The arrangement 600 also includes a third station 630 and a fourth station 640. The stations 630 and 640 may be the other stations referred to above in the description of FIG. 5. In the example of the arrangement 600, it may be considered that the third station 630 is hidden from the second station 620, e.g., the third station 630 may not decode any transmissions by the second station 620. Similarly, the fourth station 640 is hidden from the first station 610, e.g., the fourth station 640 may not decode any transmissions by the first station 610. The timing diagrams of FIG. 7-9 are described with reference to the arrangement 600.

FIG. 7 shows an example timing diagram 700 of TXOP holder and TXOP responder communications when other stations are 802.11bn stations according to various example embodiments. In this example embodiment, the timing for the TXOP holder station 610, the TXOP responder station 620 and the other stations 630 and 640 are shown. In this example, the other stations 630 and 640 are 802.11bn stations.

After a backoff period, the TXOP holder station 610 transmits the ICF 710 that includes the durations A and B as described above. The TXOP responder station 620 may receive the ICF 710 and transmit an ICR 720 in response. The ICR 720 may include the duration B in the MAC header of the ICR as was described above.

In this example, the other station 630 may also receive the ICF 710. The station 630 will understand that the ICF is not destined for the station 630 based on information in the ICF 710. However, the station 630 may set the NAV based on the information in the ICF 710. Because the station 630 is an 802.11bn station, the station 630 may understand the meaning of the duration A and duration B. Thus, as shown in FIG. 7, the station 630 may set the NAV based on adding the durations A and B from the ICF 710.

As described above, the other station 640 is hidden from the station 610 and therefore does not receive the ICF 710 and therefore does not set a NAV. The other station 640 does receive the ICR 720 that includes the duration B in the MAC header of the ICR 720. The other station 640 may set the NAV based on the duration B in the ICR 720.

The remaining operations between the TXOP holder station 610 and the TXOP responder station 620, e.g., data transmissions 730 and 740 and BA 750 are similar to the examples described above with reference to FIG. 5 and are not described again.

In the example of FIG. 7, if the TXOP responder 620 did not send the ICR 720, this is not an issue for the other stations 630 and 640. For the station 630 that set the NAV based on the ICF 710, since the station 630 is an 802.11bn station, it has the capability to reset the NAV. For example, if the station 630 does not receive either the PHY-RXEARLYSIG. indication or PHY-RXSTART. indication primitive associated with the data transmission 730 during the NAV timeout period after setting the NAV from the ICF 710, the station 630 may reset the NAV. The station 640 never set the NAV because it did not receive the ICF 710 and therefore no additional action is performed.

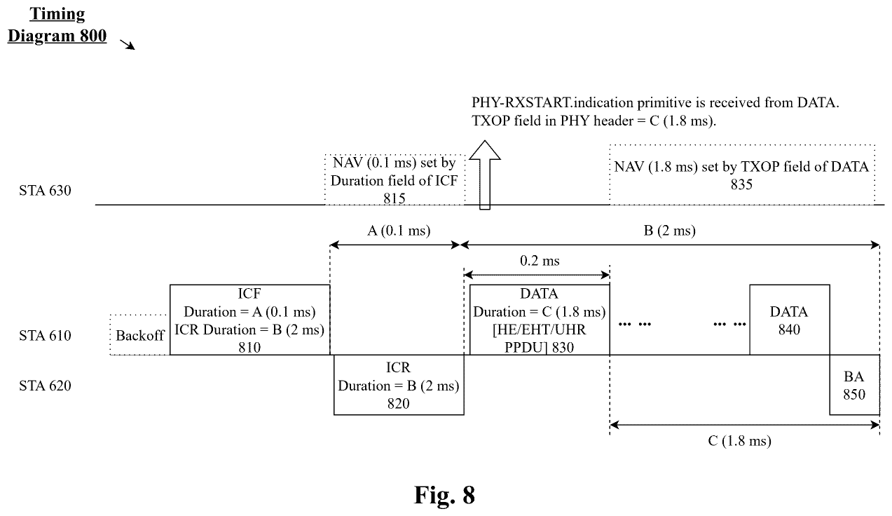

FIG. 8 shows an example timing diagram 800 of TXOP holder and TXOP responder communications when other stations are legacy stations according to various example embodiments. In this example embodiment, the timing for the TXOP holder station 610, the TXOP responder station 620 and the other station 630 are shown. In this example, the other station 630 is a legacy station, e.g., 802.11ax/be station.

After a backoff period, the TXOP holder station 610 transmits the ICF 810 that includes the durations A and B as described above. The TXOP responder station 620 may receive the ICF 810 and transmit an ICR 820 in response. The ICR 720 may include the duration B as was described above.

In this example, the other station 630 may also receive the ICF 810. The station 630 will understand that the ICF 810 is not destined for the station 630 based on information in the ICF 810. However, the station 630 may set the NAV based on the information in the ICF 810. Because the station 630 is a legacy station in this example, the station 630 may not understand the meaning of the duration B. The other station 630 may only understand the meaning of the duration A and, therefore, as shown in FIG. 8, the station 630 may set the NAV 815 based on the duration A in the ICF 810.

In this example, if the TXOP responder station 620 did not transmit the ICR 820, since the other station 630 only set the NAV 815 based on the duration A, the other station 630 may attempt to access the channel without waiting for the full TXOP duration, e.g., duration A plus duration B. Thus, the issue with as described with reference to FIGS. 2 and 4 as being unfair to legacy stations may be resolved.

However, if the TXOP responder 620 did send the ICR 820, the other station 630 needs to set a NAV for the remaining duration of the TXOP. In this example, the data transmission 830 of the TXOP may be a High Efficiency (HE) PPDU, an Extremely High Throughput (EHT) PPDU or an Ultra High Reliability (UHR) PPDU. The other station 630 may decode the Physical (PHY) layer header of the PPDU. The PHY layer header may include a TXOP duration field that may be understood by the legacy other station 630. In the example of FIG. 8, this duration is shown as duration C in the data transmission 830. The other station 630 may use this duration C to set the NAV 835 for the TXOP.

The remaining operations between the TXOP holder station 610 and the TXOP responder station 620, e.g., data transmissions 840 and the BA 850 are similar to the examples described above with reference to FIG. 5 and are not described again.

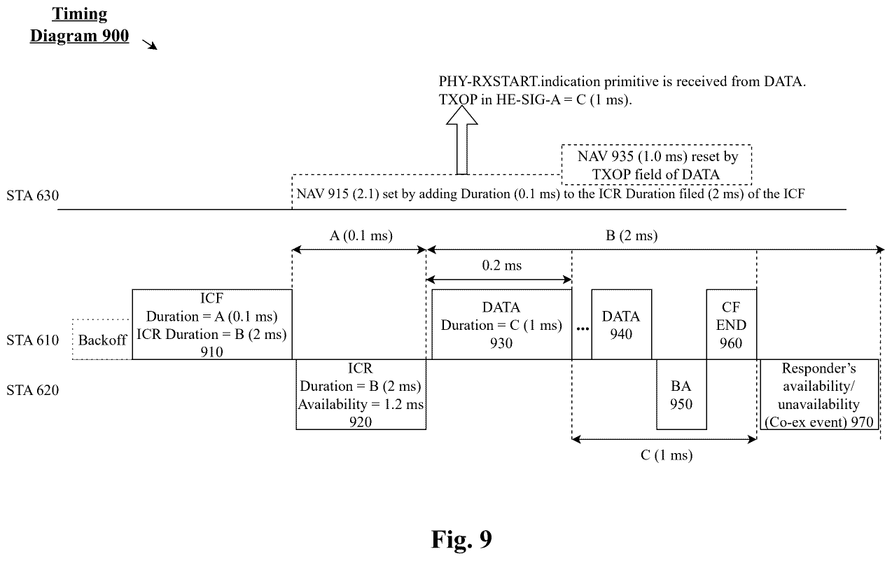

FIG. 9 shows an example timing diagram 900 of TXOP holder and TXOP responder communications when other stations are 802.11bn stations and a NAV is updated according to various example embodiments. In this example embodiment, the timing for the TXOP holder station 610, the TXOP responder station 620 and the other station 630 are shown. In this example, the other station 630 is an 802.11bn station.

After a backoff period, the TXOP holder station 610 transmits the ICF 910 that includes the durations A and B as described above. The TXOP responder station 620 may receive the ICF 910 and transmit an ICR 920 in response. The ICR 720 may include the duration B as was described above.

In this example, the other station 630 may also receive the ICF 910. The station 630 will understand that the ICF is not destined for the station 630 based on information in the ICF 910. The station 630 may set the NAV 915 based on adding the durations A and B from the ICF 910.

In the example of FIG. 9, the TXOP responder station 620 may experience a coexistence (COEX) scenario. The COEX scenario may mean that the TXOP responder station 620 becomes unavailable for a period of time during the TXOP duration, e.g., because the TXOP responder station 620 is performing Bluetooth communications. This unavailability time 970 is shown in FIG. 9. The ICR 920 sent by the TXOP responder station 620 may include the duration B in the MAC header as described above but may also include an availability duration, e.g., the difference between the duration B and when the unavailability 970 begins.

Based on the availability duration in the ICR 920, the TXOP holder station 610 may determine that the TXOP duration is to be shorter than the duration B, e.g., the TXOP may end when the unavailability duration 970 begins. Thus, in this example, the TXOP holder station 610 may include a duration C in the TXOP field in the header of the data transmission 930. This duration C may be the amount of time the TXOP holder station 610 intends to hold the channel during the TXOP but is less than the original TXOP duration. The TXOP holder station 610 is not required to relinquish the time in the TXOP in this scenario. For example, if the TXOP holder station 610 is an AP station, the AP may transmit to other stations during the unavailability of the TXOP responder station 620.

However, in the example of FIG. 9, it may be considered that the TXOP holder station 610 will end the TXOP early. This may be done by the TXOP holder station 610 sending a contention free (CF) end frame 960 after the data transmissions 930 and 940 and the corresponding BA 950. The CF end frame 960 indicates to other stations that the contention free period is over and other stations may attempt to access the channel.

In this example, the other station 630 may also receive the data transmission 930 with the duration C in the header, e.g., PHY-RXSTART indication primitive. As described above, the other station 630 initially set the NAV 915 based on the durations A and B in the ICF 910. The example embodiments allow the other station 630 to update the NAV using the duration C in the data transmission 930. Thus, the other station 630 may update the NAV to NAV 935 based on the duration C. In this manner, the other station 630 may contend for the station after the CF end frame 960 is sent by the TXOP holder station 610 rather than waiting for the original NAV 915 to expire.

When a third party station is a non-HE station and it is a hidden station from the TXOP responder, the third party station may not set the NAV for the entire TXOP duration, allowing the third party station to access the medium after the SIFS following a data frame. In such a case, if the 802.11bn AP detects multiple non-HE stations that may cause interference, the AP may define a rule for disabling this incremental NAV update. The proposed incremental NAV update mechanism may be used when the AP enables it. For example, the AP may declare the enablement of incremental NAV updates in the UHR Operation element when the HT Protection field in the HT Operation element, transmitted in the Beacon frame, is set to 0 (no protection mode).

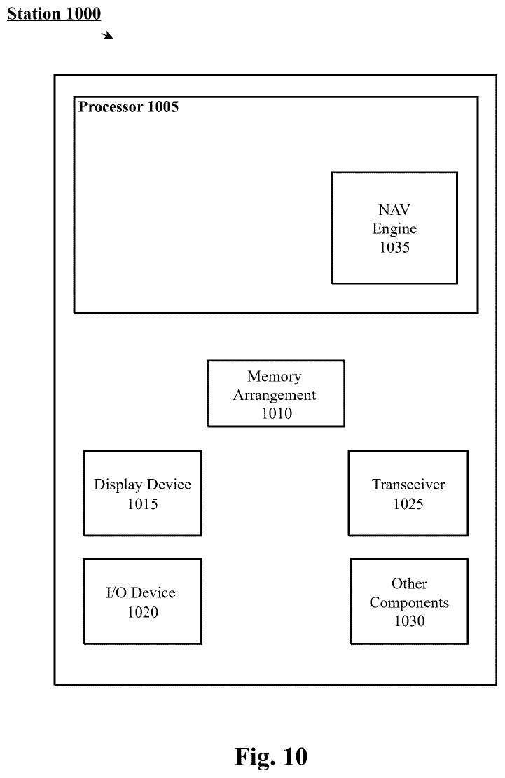

FIG. 10 shows an example station 1000 according to various example embodiments. The example station 1000 may represent, for example, the stations 110-140 of FIGS. 1 and 3 or the stations 610-640 of FIG. 6. While various components are described below for the station 1000, there is no requirement that a station have all the described components. For example, an AP will typically not include a display device.

The station 1000 may include a processor 1005, a memory arrangement 1010, a display device 1015, an input/output (I/O) device 1020, a transceiver 1025 and other components 1030. The other components 1030 may include, for example, an audio input device, an audio output device, a power supply, a data acquisition device, ports to electrically connect the station 1000 to other electronic devices, etc.

The processor 1005 may be configured to execute a plurality of engines of the station 1000. For example, the engines may include a NAV engine 1035. The NAV engine 1035 may be configured to perform operations related to setting the NAV during a TXOP. These operations may include operations performed by a TXOP holder, a TXOP responder or a third party station. Examples of these operations were described in detail above.

The above referenced engine being an application (e.g., a program) executed by the processor 1005 is only an example. The functionality associated with the engines may also be represented as a separate incorporated component of the station 1000 or may be a modular component coupled to the station 1000, e.g., an integrated circuit with or without firmware. For example, the integrated circuit may include input circuitry to receive signals and processing circuitry to process the signals and other information. The engines may also be embodied as one application or separate applications. In addition, in some stations, the functionality described for the processor 205 is split among two or more processors such as a baseband processor and an applications processor. The example embodiments may be implemented in any of these or other configurations of a wireless communication device.

The memory arrangement 1010 may be a hardware component configured to store data related to operations performed by the station 1000. The display device 1015 may be a hardware component configured to show data to a user while the I/O device 1020 may be a hardware component that enables the user to enter inputs. The display device 1015 and the I/O device 1020 may be separate components or integrated together such as a touchscreen.

The transceiver 1025 may be a hardware component configured to establish a connection with the wirelessly locatable tag or any other wireless communication device. Accordingly, the transceiver 1025 may operate on a variety of different frequencies or channels (e.g., set of consecutive frequencies). For example, the transceiver may be configured to operate on frequencies associated with the IEEE 802.11 protocols to exchange signals with other station operating on these protocols. The transceiver 1025 includes circuitry configured to transmit and/or receive signals (e.g., control signals, data signals). Such signals may be encoded with information implementing any one of the methods described herein. The processor 1005 may be operably coupled to the transceiver 1025 and configured to receive from and/or transmit signals to the transceiver 1025. The processor 1005 may be configured to encode, decode and/or process signals for implementing any one of the methods described herein.

### EXAMPLES

In a first example, a method, comprising generating, for transmission, an initial control frame (ICF) for a transmission opportunity (TXOP) comprising a first duration and a second duration, wherein the first duration is set based on a time for a TXOP responder station to respond to the ICF with an initial control response (ICR) and a Short Interframe Space (SIFS), and wherein the second duration is set based on a time for data to be transmitted to the TXOP responder station, processing, based on signaling received from the TXOP responder station, the ICR and generating, for transmission to the TXOP responder station, one or more data transmissions during the TXOP.

In a second example, the method of the first example, wherein the first duration and the second duration are included in a Medium Access Control (MAC) header of the ICF.

In a third example, the method of the first example, wherein a first one of the one or more data transmissions comprises a third duration indicating a time remaining in the second duration after transmission of the first one of the one or more data transmissions.

In a fourth example, the method of the third example, wherein the first one of the one or more data transmissions comprises a High Efficiency (HE) physical layer protocol data unit (PPDU), an Extremely High Throughput (EHT) PPDU or an Ultra High Reliability (UHR) PPDU, wherein the third duration is included in a physical (PHY) layer header of the first one of the one or more data transmissions.

In a fifth example, the method of the first example, wherein the ICR comprises an availability duration for the TXOP responder station during the TXOP, wherein the availability duration is less than the second duration.

In a sixth example, the method of the fifth example, wherein a first one of the one or more data transmissions comprises a third duration indicating a time less than the second duration, wherein the third duration is based on the availability duration.

In a seventh example, the method of the sixth example, further comprising generating, for transmission, a contention free (CF) end frame indicating a contention free period of the TXOP is ended, wherein the CF end frame is transmitted at an end of the third duration.

In an eighth second example, the method of the first example, wherein the apparatus comprises an IEEE 802.11bn access point (AP) station or an IEEE 802.11bn non-AP station.

In a ninth example, a processor configured to perform any of the methods of the first through eighth examples.

In a tenth example, a wireless communication device configured to perform any of the methods of the first through eighth examples.

In an eleventh example, a method, comprising processing, based on signaling received from a transmission opportunity (TXOP) holder station, an initial control frame (ICF) for a TXOP comprising a first duration and a second duration, wherein the first duration is set based on a time to respond to the ICF with an initial control response (ICR) and a Short Interframe Space (SIFS), and wherein the second duration is set based on a time for data to be transmitted by the TXOP holder station, generating, for transmission to the TXOP holder station, the ICR, wherein the ICR comprises the second duration and processing, based on signaling received from the TXOP holder station, one or more data transmissions during the TXOP.

In a twelfth example, the method of the eleventh example, wherein the first duration and the second duration are included in a Medium Access Control (MAC) header of the ICF.

In a thirteenth example, the method of the eleventh example, wherein the second duration is included in a Medium Access Control (MAC) header of the ICR.

In a fourteenth example, the method of the eleventh example, wherein a first one of the one or more data transmissions comprises a third duration indicating a time remaining in the second duration after the transmission of the first one of the one or more data transmissions.

In a fifteenth example, the method of the fourteenth example, wherein the first one of the one or more data transmissions comprises a High Efficiency (HE) physical layer protocol data unit (PPDU), an Extremely High Throughput (EHT) PPDU or an Ultra High Reliability (UHR) PPDU, wherein the third duration is included in a physical (PHY) layer header of the first one of the one or more data transmissions.

In a sixteenth example, the method of the eleventh example, wherein the ICR further comprises an availability duration during the TXOP, wherein the availability duration is less than the second duration.

In a seventeenth example, the method of the sixteenth example, wherein a first one of the one or more data transmissions comprises a third duration indicating a time less than the second duration.

In an eighteenth example, the method of the seventeenth example, further comprising processing, based on signaling received from the TXOP holder station, a contention free (CF) end frame indicating a contention free period of the TXOP is ended, wherein the CF end frame is transmitted at an end of the third duration.

In a nineteenth example, the method of the eleventh example, wherein the apparatus comprises an IEEE 802.11bn access point (AP) station or an IEEE 802.11bn non-AP station.

In a twentieth example, a processor configured to perform any of the methods of the eleventh through nineteenth examples.

In a twenty first example, a wireless communication device configured to perform any of the methods of the eleventh through nineteenth examples.

In a twenty second example, a method, comprising processing, based on signaling received from a transmission opportunity (TXOP) holder station, an initial control frame (ICF) for a TXOP destined for a TXOP responder station, the ICF comprising a first duration and a second duration, wherein the apparatus is not the TXOP responder station, wherein the first duration is set based on a time to respond to the ICF with an initial control response (ICR) and a Short Interframe Space (SIFS), and wherein the second duration is set based on a time for data to be transmitted by the TXOP holder station to the TXOP responder station and setting a network allocation vector (NAV) duration based on the first duration and the second duration, wherein the apparatus does not contend for a channel during the NAV duration.

In a twenty third example, the method of the twenty second example, wherein the first duration and the second duration are included in a Medium Access Control (MAC) header of the ICF.

In a twenty fourth example, the method of the twenty second example, further comprising processing, based on signaling received from the TXOP holder station, a first one of one or more data transmissions during the TXOP comprising a third duration indicating a time less than the second duration and resetting the NAV duration based on the third duration.

In a twenty fifth example, the method of the twenty fourth example, wherein the first one of the one or more data transmissions comprises a High Efficiency (HE) physical layer protocol data unit (PPDU), an Extremely High Throughput (EHT) PPDU or an Ultra High Reliability (UHR) PPDU, wherein the third duration is included in a physical (PHY) layer header of the first one of the one or more data transmissions.

In a twenty sixth example, the method of the twenty fourth example, further comprising processing, based on signaling received from the TXOP holder station, a contention free (CF) end frame indicating a contention free period of the TXOP is ended, wherein the CF end frame is transmitted at an end of the third duration.

In a twenty seventh example, the method of the twenty second example, wherein the apparatus comprises an IEEE 802.11bn access point (AP) station or an IEEE 802.11bn non-AP station.

In a twenty eighth example, a processor configured to perform any of the methods of the twenty second through twenty seventh examples.

In a twenty ninth example, a wireless communication device configured to perform any of the methods of the twenty second through twenty seventh examples.

In a thirtieth example, a method, comprising processing, based on signaling received from a transmission opportunity (TXOP) responder station, an initial response frame (ICR) for a TXOP destined for a TXOP holder station, the ICR comprising a first duration, wherein the apparatus is not the TXOP holder station, wherein the first duration is set based on a time for data to be transmitted by the TXOP holder station to the TXOP responder station and setting a network allocation vector (NAV) duration based on the first duration, wherein the apparatus does not contend for a channel during the NAV duration.

In a thirty first example, the method of the thirtieth example, wherein the first duration is included in a Medium Access Control (MAC) header of the ICR.

In a thirty second example, the method of the thirtieth example, further comprising processing, based on signaling received from the TXOP holder station, a first one of one or more data transmissions during the TXOP comprising a second duration indicating a time less than the first duration and resetting the NAV duration based on the second duration.

In a thirty third example, the method of the thirty second example, wherein the first one of the one or more data transmissions comprises a High Efficiency (HE) physical layer protocol data unit (PPDU), an Extremely High Throughput (EHT) PPDU or an Ultra High Reliability (UHR) PPDU, wherein the second duration is included in a physical (PHY) layer header of the first one of the one or more data transmissions.

In a thirty fourth example, the method of the thirty second example, further comprising processing, based on signaling received from the TXOP holder station, a contention free (CF) end frame indicating a contention free period of the TXOP is ended, wherein the CF end frame is transmitted at an end of the second duration.

In a thirty fifth example, the method of the thirtieth example, wherein the apparatus comprises an IEEE 802.11bn access point (AP) station or an IEEE 802.11bn non-AP station.

In a thirty sixth example, a processor configured to perform any of the methods of the thirtieth through thirty fifth examples.

In a thirty seventh example, a wireless communication device configured to perform any of the methods of the thirtieth through thirty fifth examples.

In a thirty eighth example, a method, comprising processing, based on signaling received from a transmission opportunity (TXOP) holder station, an initial control frame (ICF) for a TXOP destined for a TXOP responder station, the ICF comprising a first duration, wherein the apparatus is not the TXOP responder station, wherein the first duration is set based on a time to respond to the ICF with an initial control response (ICR) and a Short Interframe Space (SIFS) and setting a network allocation vector (NAV) duration based on the first duration, wherein the apparatus does not contend for a channel during the NAV duration.

In a thirty ninth example, the method of the thirty eighth example, wherein the first duration is included in a Medium Access Control (MAC) header of the ICF.

In a fortieth example, the method of the thirty eighth example, further comprising processing, based on signaling received from the TXOP holder station after the first duration, a first one of one or more data transmissions during the TXOP comprising a second duration that is set based on a time for data to be transmitted by the TXOP holder station to the TXOP responder station and setting a second NAV duration based on the second duration, wherein the apparatus does not contend for the channel during the second NAV duration.

In a forty first example, the method of the fortieth example, wherein the first one of the one or more data transmissions comprises a High Efficiency (HE) physical layer protocol data unit (PPDU), an Extremely High Throughput (EHT) PPDU or an Ultra High Reliability (UHR) PPDU, wherein the second duration is included in a physical (PHY) layer header of the first one of the one or more data transmissions.

In a forty second example, the method of the thirty eighth example, wherein the apparatus comprises a legacy IEEE 802.11 access point (AP) station or a legacy IEEE 802.11 non-AP station.

In a forty third example, a processor configured to perform any of the methods of the thirty eighth through forty second examples.

In a forty fourth example, a wireless communication device configured to perform any of the methods of the thirty eighth through forty second examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

What is claimed:

1. An apparatus comprising processing circuitry coupled to memory, wherein the processing circuitry is configured to:
generate, for transmission, an initial control frame (ICF) for a transmission opportunity (TXOP) comprising a first duration and a second duration,
wherein the first duration is set based on a time for a TXOP responder station to respond to the ICF with an initial control response (ICR) and a Short Interframe Space (SIFS), and
wherein the second duration is set based on a time for data to be transmitted to the TXOP responder station;
process, based on signaling received from the TXOP responder station, the ICR; and
generate, for transmission to the TXOP responder station, one or more data transmissions during the TXOP.

2. The apparatus of claim 1, wherein the first duration and the second duration are included in a Medium Access Control (MAC) header of the ICF.

3. The apparatus of claim 1, wherein a first one of the one or more data transmissions comprises a third duration indicating a time remaining in the second duration after transmission of the first one of the one or more data transmissions.

4. The apparatus of claim 3, wherein the first one of the one or more data transmissions comprises a High Efficiency (HE) physical layer protocol data unit (PPDU), an Extremely High Throughput (EHT) PPDU or an Ultra High Reliability (UHR) PPDU, wherein the third duration is included in a physical (PHY) layer header of the first one of the one or more data transmissions.

5. The apparatus of claim 1, wherein the ICR comprises an availability duration for the TXOP responder station during the TXOP, wherein the availability duration is less than the second duration.

6. The apparatus of claim 5, wherein a first one of the one or more data transmissions comprises a third duration indicating a time less than the second duration, wherein the third duration is based on the availability duration.

7. The apparatus of claim 6, wherein the processing circuitry is further configured to:
generate, for transmission, a contention free (CF) end frame indicating a contention free period of the TXOP is ended, wherein the CF end frame is transmitted at an end of the third duration.

8. The apparatus of claim 1, wherein the apparatus comprises an IEEE 802.11bn access point (AP) station or an IEEE 802.11bn non-AP station.

9. An apparatus comprising processing circuitry coupled to memory, wherein the processing circuitry is configured to:
process, based on signaling received from a transmission opportunity (TXOP) holder station, an initial control frame (ICF) for a TXOP comprising a first duration and a second duration,
wherein the first duration is set based on a time to respond to the ICF with an initial control response (ICR) and a Short Interframe Space (SIFS), and
wherein the second duration is set based on a time for data to be transmitted by the TXOP holder station;
generate, for transmission to the TXOP holder station, the ICR, wherein the ICR comprises the second duration; and
process, based on signaling received from the TXOP holder station, one or more data transmissions during the TXOP.

10. The apparatus of claim 9, wherein the first duration and the second duration are included in a Medium Access Control (MAC) header of the ICF.

11. The apparatus of claim 9, wherein the second duration is included in a Medium Access Control (MAC) header of the ICR.

12. The apparatus of claim 9, wherein a first one of the one or more data transmissions comprises a third duration indicating a time remaining in the second duration after the transmission of the first one of the one or more data transmissions.

13. The apparatus of claim 9, wherein the ICR further comprises an availability duration during the TXOP, wherein the availability duration is less than the second duration.

14. The apparatus of claim 13, wherein a first one of the one or more data transmissions comprises a third duration indicating a time less than the second duration.

15. The apparatus of claim 14, wherein the processing circuitry is further configured to:
process, based on signaling received from the TXOP holder station, a contention free (CF) end frame indicating a contention free period of the TXOP is ended, wherein the CF end frame is transmitted at an end of the third duration.

16. The apparatus of claim 9, wherein the apparatus comprises an IEEE 802.11bn access point (AP) station or an IEEE 802.11bn non-AP station.

17. An apparatus comprising processing circuitry coupled to memory, wherein the processing circuitry is configured to:
process, based on signaling received from a transmission opportunity (TXOP) holder station, an initial control frame (ICF) for a TXOP destined for a TXOP responder station, the ICF comprising a first duration and a second duration, wherein the apparatus is not the TXOP responder station,
wherein the first duration is set based on a time to respond to the ICF with an initial control response (ICR) and a Short Interframe Space (SIFS), and
wherein the second duration is set based on a time for data to be transmitted by the TXOP holder station to the TXOP responder station; and
set a network allocation vector (NAV) duration based on the first duration and the second duration, wherein the apparatus does not contend for a channel during the NAV duration.

18. The apparatus of claim 17, wherein the first duration and the second duration are included in a Medium Access Control (MAC) header of the ICF.

19. The apparatus of claim 17, wherein the processing circuitry is further configured to:
process, based on signaling received from the TXOP holder station, a first one of one or more data transmissions during the TXOP comprising a third duration indicating a time less than the second duration; and
reset the NAV duration based on the third duration.

20. The apparatus of claim 19, wherein the processing circuitry is further configured to:
process, based on signaling received from the TXOP holder station, a contention free (CF) end frame indicating a contention free period of the TXOP is ended, wherein the CF end frame is transmitted at an end of the third duration.
